(19) United States
(12) Patent Application Publication
(10) Pub. No.: US 2016/0237732 A1
(43) Pub. Date: Aug. 18, 2016

(54) Door Closure System, and Networked Fire Alarm System

(71) Applicant: R. Darryl Kerley, Oak Ridge, TN (US)

(72) Inventor: R. Darryl Kerley, Oak Ridge, TN (US)

(21) Appl. No.: 15/044,042

(22) Filed: Feb. 15, 2016

Related U.S. Application Data
(60) Provisional application No. 62/116,777, filed on Feb. 16, 2015.

(51) Int. Cl. E05F 15/72; G08B 17/00

(52) U.S. Cl. CPC E05F 15/72; G08B 17/00; E05Y 2900/132

(57) ABSTRACT

A door closure system comprising a mechanically-biased door closer connected to a support surface on or adjacent a hinged door. The system also includes a rotating door closure arm having a proximal end connected to the door closer, and a distal end configured to move from a stowed position to an extended position in order to close the door. The door closure system includes a relay switch that receives a closure signal from a fire detection device, wherein the relay switch closes a circuit upon detection of the closure signal. Closing the circuit provides an electrical coupling between a battery and a voltage converter. The voltage converter increases the battery voltage and provides an increased output voltage to an electronic strike. In response the electronic strike opens and releases the door closer which closes the door.

### STATEMENT OF RELATED APPLICATIONS

Applicant claims the benefit of U.S. Patent Application Ser. No. 62/116,777 filed Feb. 16, 2015. The provisional application is incorporated herein by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

1. Field of the Invention

This invention relates generally to the field of door closure systems, particularly those utilizing a magnetic or electro-magnetic force for controlling the position of a hinged door. Additionally, the invention relates to networked fire alarm systems.

2. General Discussion of Technology

Prior to home central heating and air conditioning systems, many residents kept the doors inside their homes closed to conserve energy and to assist with heating and cooling of individual bedrooms in the home. In the event of fire, fire service professionals would teach occupants to roll out of their beds, crawl to the bedroom door, and feel the door to see if it was hot before opening. Occupants could then proceed to safety outside the structure, or assist children therein. If the door was hot, occupants were taught to remain inside the room and open the windows.

This curriculum is still being taught in most fire departments in the United States. Each year during fire prevention month, thousands of fire departments speak to many thousands of kindergarten and elementary school students, where the Exit Drill in The Home (EDITH) program is taught. In this curriculum, the fire departments teach participants to develop a fire plan for escape. In the fire escape plan, fire departments teach the students to roll off the bed, crawl to the door and feel the inside surface of the door. If the door is hot, then the fire may be immediately outside the bedroom and the students are taught to crawl to the bed room window and, if possible, exit. Props are frequently set up at the elementary schools to teach students the EDITH program.

Recently, new fire burn and progression research has been conducted by the Underwriters Laboratories (UL), the National Institute of Standards and Technology (NIST), Factory Mutual (FM) and fire marshal offices and fire training academies across the nation. Burn tests have been conducted to document heat profiles within sacrificial homes during a fire. As part of the testing, thermocouples are placed at different locations within the test homes. The thermocouples monitor temperature at different locations during initial fire consumption of a home (before the fire is put out).

A thermocouple is a temperature-measuring device consisting of two dissimilar conductors that contact each other at one or more spots, where a temperature differential is experienced by the different conductors (or semiconductors). The thermocouple produces an output voltage when the temperature of one of the spots differs from the reference temperature at other parts of the circuit. Thermocouples are a widely used type of temperature sensor for measurement and control, and can also convert a temperature gradient into an electrical current.

Of interest, it has been determined that in some homes if an occupant is in a bedroom adjacent to a room that has caught fire, then the fire can reach and exceed 1,600° F. when the door is left open. However, if the door to the occupied bedroom remains closed, then the temperature is much lower, e.g., below 100° F., and the fire is survivable. This also allows the occupant sufficient time to escape through the window even if they are required to deploy an emergency escape ladder or jump into a safety net.

Test burns have proved that a fire cannot grow as quickly if the door to the fire room is closed. The buildup of carbon monoxide and the reduction of oxygen will cause the fire to slow in growth until air is introduced. By closing doors, the fire progression is slowed and movement of smoke and heat throughout the structure is minimized. The test burns have also proven that if an individual is in a room with the door closed and the adjacent room is on fire, the occupied room with a closed door remains tenable for several minutes allowing the individual to call for help and escape through a window if necessary.

FIG. 1 is a Cartesian coordinate, or graph, charting temperature as a function of time in a first residential burn test. The graph represents a fire temperature progression curve showing the temperatures at the ceiling, four feet down from the ceiling, and 10-inches above the floor in the fire room. The graph also charts temperature in an adjacent room with the door closed. It is observed that the fire began to develop at 69 seconds from ignition and continued to grow to 1,400° F. (ceiling temp) at 159 seconds (2.5 minutes), approximately 600° F. at four feet from the ceiling at 159 seconds, and approximately 210° 10-inches from the floor at 154 seconds. The fire room went to flashover above 1,150° in approximately 150 seconds and grew to over 1,400° until water was applied. During all of this, the adjacent room (with the door closed) maintained a temperature below 110°.

FIG. 2 is another Cartesian coordinate charting temperature as a function of time but in a second residential burn test. Here, flashover (1,150° F.) took place in the living room in approximately 71 seconds, but the temperature of the adjacent room with the door closed remained at about 55° (ambient temperature on this day) throughout the burn. It can again be seen that door closure plays an important role in protecting occupants within a house from fire.

A problem arises in that most occupants today no longer sleep with their doors closed; instead, bedrooms doors are kept open to permit air flow and proper air handling for central heating and cooling systems. When a fire develops inside such a home at night (or during sleeping hours), fire (heat and smoke) spreads rapidly from one room to another.

For homes that have a central heating and air conditioning system, if the door to a bedroom is to be kept closed, the manufactures recommend a one-and-one-half inch opening between the door and the floor. This allows at least some air flow from the room to maintain a more uniform circulation throughout the structure and to reduce load on the air handlers. However, as noted above, occupants today primarily sleep with the doors open to maintain comfortable temperatures throughout the structure. Further, parents with children prefer to sleep with doors open so that they can hear their children cry or request help in the night.

Accordingly, a need exists for an improved door closure system, wherein a magnetic (or electro-magnetic) force holding a door open is released in response to a signal from a smoke alarm or other fire detector, and the door is closed. A need further exists for a networked fire alarm system, wherein signals may be sent between smoke alarms so that doors may be closed in more than one room when smoke or heat is detected.

### SUMMARY OF THE INVENTION

A door closure system is first provided herein. In one embodiment, the door closure system first includes a mechanically-biased door closer. The door closer may apply its bias through a wound spring, through an electric motor, or through other means for mechanically moving a door from its open position to its closed position. In one aspect, the door closer is configured to be connected to a fixed surface adjacent a hinged door. An example of a fixed surface is a wall that resides in parallel relation to the door when the door is in its open position. Alternatively, the fixed surface may be a door frame behind or above the door.

The door closure system also includes a rotating arm. The arm has a first (or proximal) end operatively attached to the door closer, and a second (or distal) end configured to engage the door when the door closure system is activated. In one embodiment, activating the door closure system causes the rotating arm to push the door closed. In another embodiment, activating the door closure system causes the arm to pull the door closed.

In one aspect, the door closure system includes a relay switch receiving at least one closure signal from a fire detection device, wherein the relay switch closes a circuit upon detection of the at least one closure signal. The closing the circuit of the door closure system provides an electrical coupling between a battery and a voltage converter (or so-called transformer), wherein the battery presents an input voltage to the voltage converter through the coupling.

The voltage converter of the door closure system increases the input voltage and provides an increased output voltage to an electronic strike. The electronic strike of the door closure system receives the increased output voltage as an input, wherein the receiving comprises actuating the electronic strike and mechanically releasing the door closer. It should be understood that the electronic strike may be considered a stop or a reciprocating stop, which may be in other forms such as a solenoid.

A mechanical biasing force of the released door closer closes the door. The door closure system under an embodiment includes a 9 volt battery. The input voltage of the door closure system may be 9 volts. The increased output voltage of the door closure system may then be 12 volts or, alternatively, 14 volts. In any aspect, the voltage activates the electronic strike, releasing the door and allowing the mechanical biasing force to move the door into its closed (and fire-safe) position.

The door closure system of an embodiment comprises a momentary push button switch, wherein activating the switch closes the circuit. The push button switch, thus, acts as a test for the system.

Preferably, the door closure system includes a housing. The housing is secured to an adjacent wall and holds the battery, the relay switch, the electronic strike, the push button switch and the voltage converter. In addition, the housing includes a support for the proximal end of the articulating arm, and provides the means for the biasing force.

The at least one closure signal may optionally originate from a smoke detector configured to communicate signals to a voltage converter by means of a wire. Alternatively, the smoke detector may be configured to communicate signals to the voltage converter by means of a wireless signal, or an acoustical signal. Preferably, the door closure will have a transceiver for receiving the wireless signal, and the system will communicate with a central fire protection system located within a structure which houses the door.

A networked fire protection system is also provided herein. In one embodiment, the system includes a plurality of fire detection devices, such as so-called smoke detectors. Each device of the plurality of fire detection devices is wirelessly coupled to every other fire detection device, wherein each fire detection device wirelessly communicates with a corresponding door closing component. In this way, if one fire detection device senses a condition of fire (such as the presence of smoke), then all door closing components activate to close their corresponding door.

A first device of the plurality of fire detection devices detects an indication of a fire and produces a closure signal. This closure signal is then communicated to every other fire detection device through a wireless communication protocol. Each device of the plurality of fire detection devices wirelessly communicates the closure signal to each corresponding door closing component. Each corresponding door closing component includes a mechanically-biased door closer connected to a surface on or adjacent a corresponding door.

In a related embodiment, each door closing component includes a sound detector tuned to receive frequencies generated by fire detectors upon detection of a condition indicative of fire. Such door closing components may be installed into a business or a residence having pre-existing smoke detectors. A door closing component is associated with doors to selected rooms, such as bedrooms or offices.

Each corresponding door closing component may be arranged in according with the door closure systems described above. For example, each door closing component may include a housing secured to an adjacent wall. The housing holds the battery, the electronic strike, the push button switch and the voltage converter for each component. In addition, the housing includes a support for the proximal end of the articulating arm, and provides the means for the biasing force. Each corresponding door closing component of an embodiment includes a relay switch receiving the closure signal from a corresponding fire detection device, wherein the relay switch closes a circuit upon detection of the closure signal, the closing the circuit providing an electrical coupling between the battery and the voltage converter, wherein the battery presents an input voltage to the voltage converter through the coupling.

### BRIEF DESCRIPTION OF THE DRAWINGS

So that the present inventions can be better understood, certain drawings, charts, graphs and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a Cartesian coordinate charting temperature as a function of time in a first residential burn test.

FIG. 2 is another Cartesian coordinate charting temperature as a function of time but in a second residential burn test.

FIG. 3 is a top view of a door closure system in accordance with the present invention, in one embodiment. A housing has been removed from the system revealing certain components.

FIG. 4A is a perspective view of the door closure system of FIG. 3, taken from a first end. FIG. 4B is a perspective view of the door closure system of figure, taken from a second opposite end. In each view, the housing installed onto a base plate, and a rotating arm is in its stowed position.

FIG. 5A is a perspective view of the door closure system of FIGS. 4A and 4B. The system is ready to be secured to a wall or other support structure. A housing is provided. FIG. 5B is another perspective view of the door closure system of FIGS. 4A and 4B, but with the housing removed, revealing selected components.

FIG. 6A is a top view of the door closure system of FIG. 3 The system is shown mounted to a wall adjacent a door. The door is shown in its open position. FIG. 6B is another top view of the door closure system of FIG. 3 Here, the system has been activated to move the door to its closed position.

FIG. 7 is an operational flow chart showing a progression of steps for the door closure system of the present invention, in one embodiment.

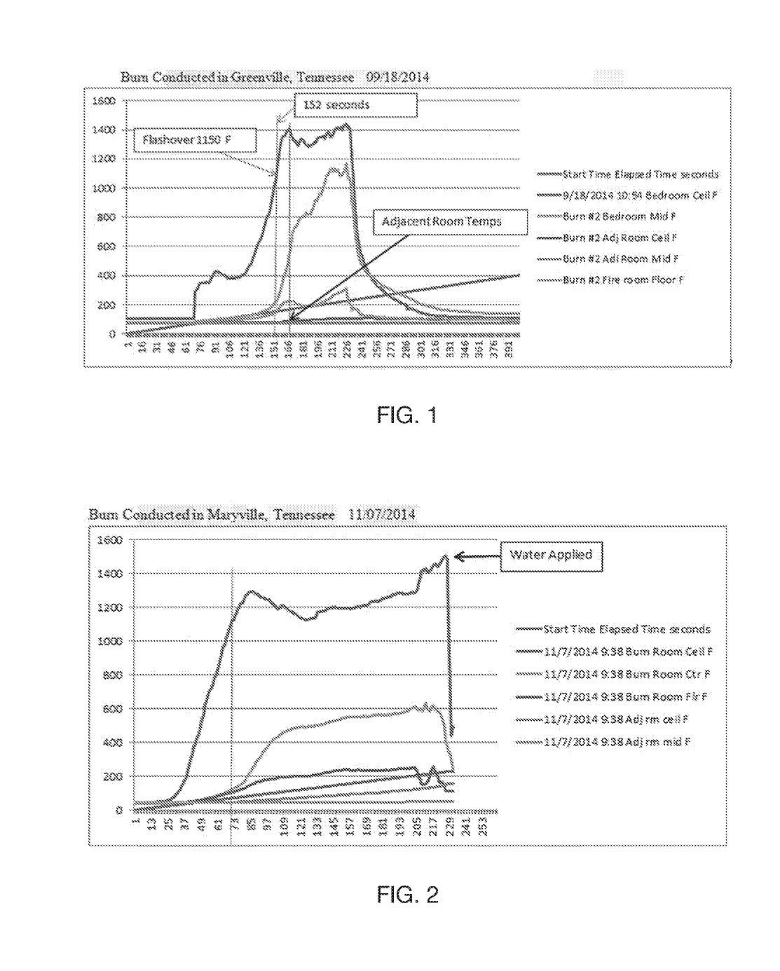

### DETAILED DESCRIPTION OF CERTAIN EMBODIMENTS

### Description of Selected Specific Embodiments

The inventions are described herein in connection with certain specific embodiments. However, to the extent that the following detailed description is specific to a particular embodiment or a particular use, such is intended to be illustrative only and is not to be construed as limiting the scope of the inventions.

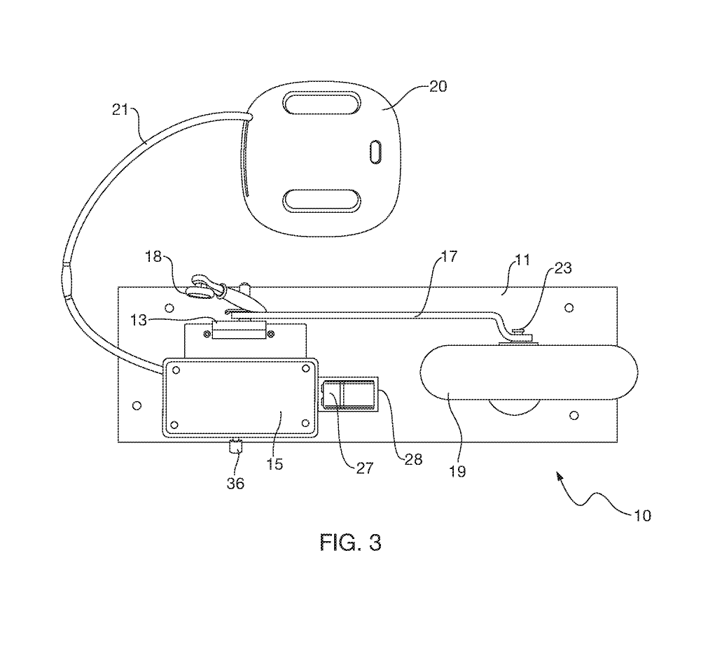

FIG. 3 is a top view of a door closure system 10 in accordance with the present invention, in one embodiment. A housing has been removed to reveal certain components.

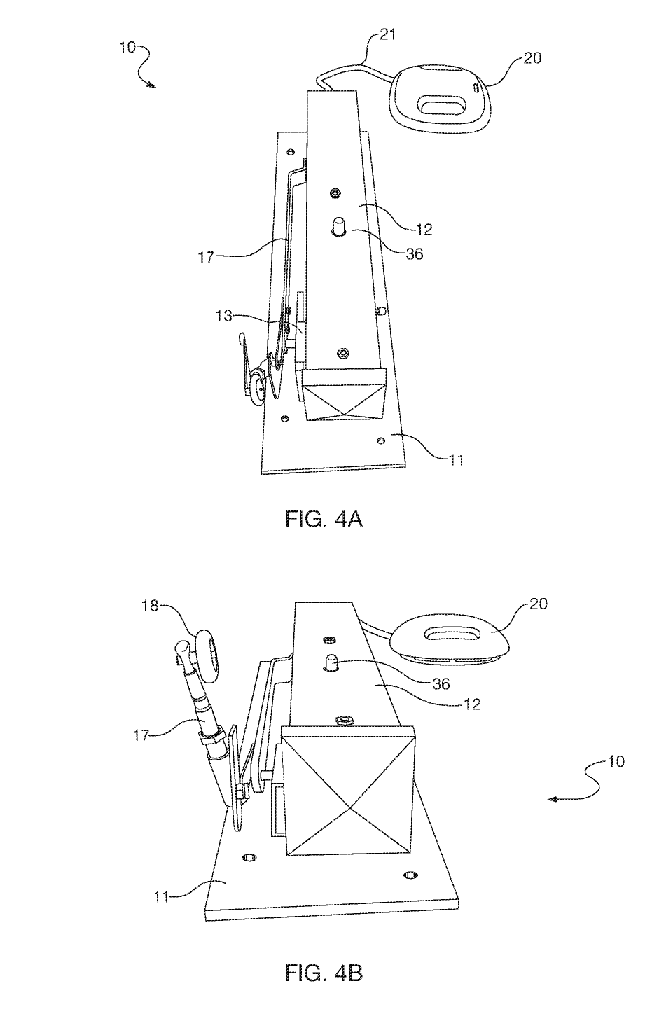

FIG. 4A is a perspective view of the door closure system 10 of FIG. 3, taken from a first end. FIG. 4B is a perspective view of the door closure system 10 of FIGS. 3A and 3B, taken from a second opposite end. In each view, a housing 12 is installed onto a base plate 11, and a rotating arm 17 is in its stowed position along the housing 12.

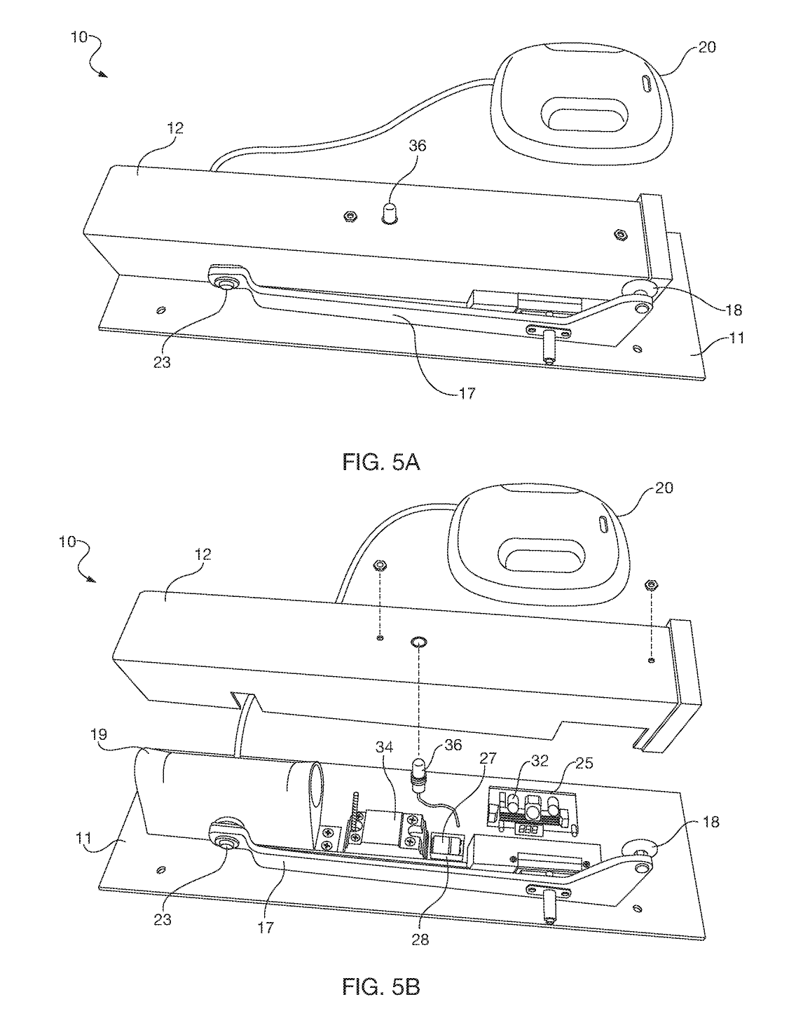

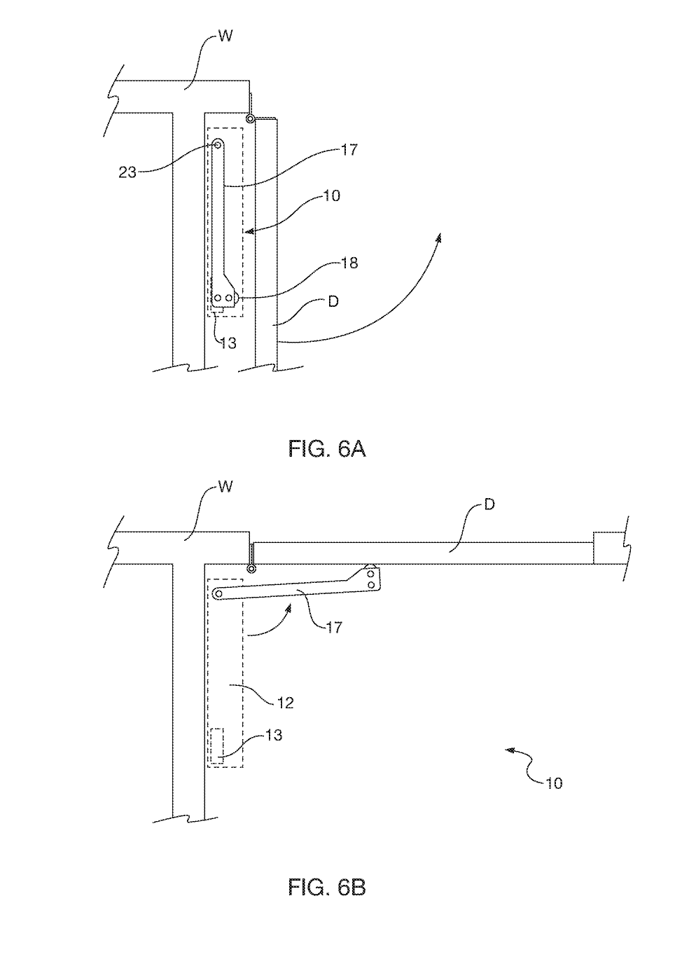

FIG. 5A is a perspective view of the door closure system 10 of FIGS. 4A and 4B. The system 10 is ready to be secured to a wall or other support structure (shown at “W” in FIG. 6A). The housing 12 is provided. FIG. 5B is another perspective view of the door closure system 10 of FIGS. 4A and 4B, but with the housing 12 removed, revealing selected components.

FIG. 6A is a top view of the door closure system of FIG. 3 The system is shown mounted to a wall adjacent a door. The door is shown in its open position. FIG. 6B is another top view of the door closure system of FIG. 3 Here, the system has been activated to move the door to its closed position.

FIG. 6A is a top view of the door closure system 10 of FIG. 3. The system 10 is shown mounted to a wall structure “W” adjacent a door “D”. The door “D” is shown in its open position. FIG. 6B is another top view of the door closure system 10 of FIG. 3. Here, the system 10 has been activated to move the door “D” to its closed position.

Referring now to FIGS. 3, 4A, 4B, 5A, 5B, 6A and 6B together, the door closure system 10 generally includes the plate 11, the electronic control housing or cover 12 mountable to the plate 11, an electric door strike 13 controlled by electronics or a controller 15 within a control box, a rotating closure arm 17, and a mechanical door closer 19, preferably a non-electric, spring loaded device that automatically rotates a shaft (later identified as shaft 23) upon actuation. The plate 11 supports these components, while also being configured to be attached to a wall W above or otherwise adjacent to a door D. The wall W may include a door frame, or may be any wall surface adjacent to the door D.

The cover 12 serves as a housing to contain and protect the electronic and mechanical components of the system 10, and to provide an aesthetically pleasing appearance. The electronic control box 15 is provided over the electrical components for protection.

Of interest, a conventional smoke sensing device or smoke alarm 20 is shown in phantom lines in FIG. 3. The smoke alarm 20 is electrically coupled to the door closure system 10. A wire or cable 21 extends from the smoke alarm 20 to the door closure system 10. The cable 21 delivers an electronic signal from the smoke alarm 20 to the electronic control box 15 in the event a fire event is detected. The system 10 may be utilized in conjunction with any conventionally known ancillary electronic device or fire detection device, such as a smoke detector, a carbon monoxide detector, a heat sensor or other device utilized to sense the presence of a fire condition.

The mechanical door closer 19 has a shaft 23 which extends from the housing 12. The closer 19 controls the door closure arm 17, which may be a hinged or an articulating arm. The arm is shown in FIG. 3 in phantom. The arm 17 may be a one piece arm, as shown in the preferred embodiment, or a two piece pivoting arm, having a roller or wheel 18 located at its distal end which is adapted to engage and roll upon the surface of the door D facing the system 10. The two piece rotating arm may be better suited for use with a door which is mounted in a central portion of a wall rather than adjacent a support wall set generally normal to the door D. The arm 17 includes a detent pin or post 22 which extends from the arm so as to be releaseably engageable with the electronic door strike 13. The post 22 may be a spring-loaded post to enable the post 22 to be biased when spring-loading the mechanical door closer by moving the arm 17 to its stowed position wherein the strike 13 engages and holds post 22. The post 22 may also extend through the arm 17 so as to extend from the opposite surface to provide a grasping handle which may aid a person in moving the arm 17 to its spring loaded, stowed position.

The plate 11 is configured to be secured to a surface of a wall W adjacent a hinged door D. Preferably, the plate 11 is placed along a top of the wall W so as to engage a top, rear surface of the door D. However, the system 10 may also be placed at other locations adjacent the door. The plate 11 is configured to support the housing 12, the door closer 19, the electronic control box 15 and the other system components, and to support the proximal end of the rotating arm 17.

The arm 17 may be a Universal Hardware heavy-duty residential door closure arm. The arm 17 is mechanically connected to the shaft 23 of Universal Hardware Model #4013 Heavy-Duty residential door closer.

The electronic control box 15 houses a circuit board 25 which is coupled to and powered by a conventional 9-volt battery 27. The battery 27 supplies power to the electrical components of the system 10. In one aspect, movement of the arm 17 is aided or provided by an electronic motor (not shown), which provides a rotational force at the proximal end of the arm 17. The battery 27 is positioned within a Philmore battery cover or box 28 which includes conventional battery terminal connectors or contacts.

The circuit board 25 is coupled to and controls an electric door strike 13. The representative door strike 13 may be an Aiphone EL-12S (12 volt) door strike. The door strike 13 resides adjacent the electronics control box 15.

A voltage converter 32 is coupled to the circuit board 25. The voltage converter 32 includes a digital voltmeter. The voltage converter may be a RioRand Adjustable Boost 3-3.5 V 5/12V DC regulated power supply. The voltage converter 32 also resides within the electronics control box 15. The voltage converter serves to increase (or bump up) the 9-volt input from the battery 27 to 12 (or more) volts on the output side of the voltage converter 32.

A relay 34 is electrically coupled to the voltage converter 32. The relay 32 may be an NTE Relay; SSR; Power; SPST-NO; Cur-Rtg 25A; Ctrl-V 3-32DC; Vol-Rtg 48-280AC; Pnl-Mnt.

The system 10 optionally includes a push-button reset switch 36. The switch 36 is used for releasing the door manually. When assembled, the push-button reset switch 36 will extend through the housing 12. The switch 36 enables a home resident to periodically test the operability of the system 10.

The combination of the circuit board 23, the battery 27, the voltage converter 32, the relay 34, and the push-button switch 36 may be considered an electronic controller, in whole or in part, if portions of these components are eliminated because of a redesign, configuration, or change in electronic components which renders them unnecessary.

In use, the door closer 19 is supplied an electronic signal from one of three potential devices. In one example, a trigger signaling device may be a 4-volt signal obtained from the activation of a conventional smoke or carbon monoxide detector, such as a Kidde 2-in-1 signaling smoke and carbon monoxide alarm KN-COSM-B-RF. When smoke, heat or carbon monoxide is detected, the detector 20 activates and produces a 4.1 volt current to the internal circuit board 25 and thereby to the input side of the NTE relay switch 34 of the door closure system 10. This causes the relay 34, which is normally open, to close and completes the 9-volt current loop from the 9-volt battery 27 to the converter 32. The voltage converter 32 then increases the 9-volt input from the battery to 12 plus volts on the output side of the voltage converter 32.

The output side of the voltage converter 32 is wired to the 12-volt door strike 13 so that electronic communication is established between the circuit board 23 of the controller and the strike 13. When the 12 to 14 volt signal is received by the door strike 13 from the voltage converter 32, the door strike 13 retracts, thereby releasing arm post 22 and allowing the door closure arm 17 to close the door D. The releasing of the spring-biased and loaded arm 17 allows the mechanical door closer 19 to commence rotation of its shaft 23 through the potential force therein. The resulting rotation of the shaft moves the arm 17 coupled thereto from its stowed or retracted position separate and disengaged from the door while in a door open position, shown in FIG. 5, towards its extended position shown in FIG. 6 contacting and engaging the door D in a door closed position. It should be understood that the mechanical door closure 19 has a potential force when in the stowed position that is released to move the arm 17 to its extended position. The arm's wheel 18 allows the distal end of the arm 17 to push against and ride upon the door D during the closing process without scratching or otherwise harming the door D.

The test and reset switch or button 36 serves two functions. When the system is activated by the smoke alarm 20, it is not desired that the electric door strike 13 be reset and accidentally allow the door D to remain open during a fire event; therefore the NTE relay 34 remains closed and maintains the 9-volt current to the system 10 to maintain the door strike 13 in an open position until the momentary push button reset switch 36 is pushed. Once the reset switch 36 is pushed, the NTE relay 34 opens up and breaks the 9-volt current to the voltage converter 32. This allows the closure arm 17 to be rotated back into its loaded position for the next smoke alarm activation. Once the arm 17 is reset into the loaded position, the door D will open and close manually without interference from the door closure system 10.

The test and reset switch 36 can also be used to activate the door closer system 10 manually for the monthly test. When the reset switch 36 is used to activate the system 10, the 9 volt battery current flows directly through the push button switch 36 and does not activate the NTE relay 34.

The system 10 can also be activated by the 9- or 12-volt current supplied by other electronic devices such as a SAFEAWAKE Bed Shaker system. A bed shaker system is used by individuals who are deaf or who are elderly (difficult to awaken). In operation, when the bed shaker system detects a condition indicative of fire, the bed shaker portion of the system will begin to shake. In the present invention, the bed shaker system will also send a signal to the door closure system 10 to close the door D. Alternatively, when any smoke alarm activates within the detection distance of the bed shaker, the bed vibrator is activated and an electrical signal is sent to the door closer 19 to release the door strike 12 and cause the door D to close.

The system 10 can also be activated by an electrical signal sent from a burglar alarm system. In this instance, if the burglar alarm system detects an intrusion into a home, an electrical signal (including a wireless signal) may be sent to the door closure system 10 to close the door D.

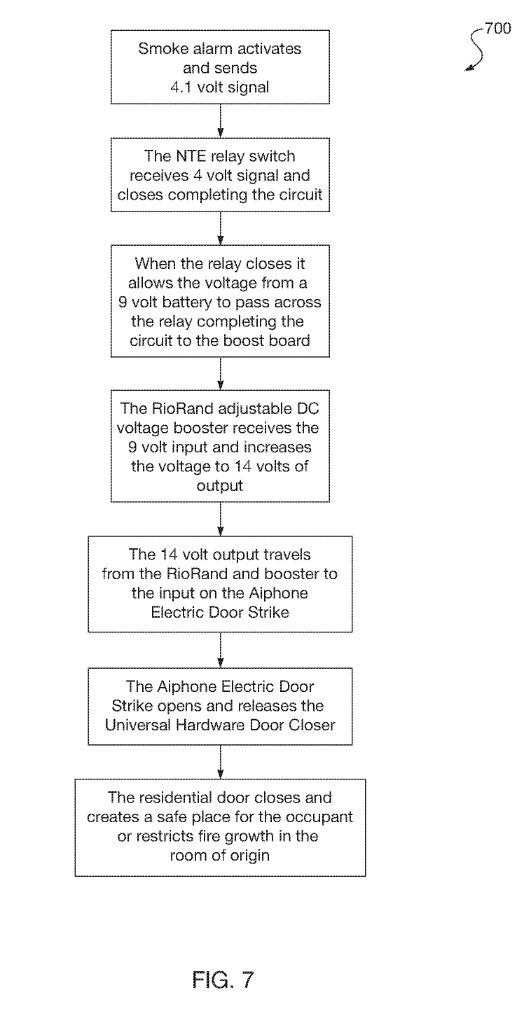

FIG. 7 is an operational flow chart 700 showing a progression of steps for the door closure system of the present invention, in one embodiment. First, a smoke alarm 20 detects fire based on the presence of smoke, the sensing of heat above a threshold value, or other parameter. The smoke alarm them sends a signal, such as a 4.1-volt signal to electronic components.

The NTE relay switch 34 receives the 4.1-volt signal and closes, completing an electronic circuit in the voltage converter 32. When the relay 34 closes in response to the signal, this allows the voltage from the 9-volt battery to pass across the relay 34, completing the circuit to the voltage converter 32. The voltage converter 32 receives the 9-volt input, and increases the voltage to 12 volts or, more preferably, 14 volts of output.

The 14-volt output travels from the voltage converter 32 to the input on the electric door strike 13. The door strike 13 opens and releases the mechanical door closer 19. At this point, the mechanical biasing force of the door closer 19 rotates the arm 17 into engagement with the door D, which thereby closes the door D, creating a safer bedroom for the occupant(s), and restricting the spread of fire from the room of origin.

It should be understood that there are differences in this residential door control product and known commercial fire door control units of the prior art. For example, commercial fire doors that are allowed to be open during normal conditions have door holders that always holds the door open with a 12/24-dc or 120-volt ac magnetic holder. These are always hard wired to the fire alarm panel and release the door when the fire alarm activates. If the door needs to be closed, then a person must pull the door free from the magnetic closer. In some cases, the pulling of the door from the magnetic holder pulls the magnetic device from the wall and will leave holes in the wall. This action will require reinstallation of the magnetic holder and/or repair of the wall.

Second, commercial fire doors that are required to be in the closed position at all times have the door closers mounted to the door and will reclose the door anytime someone passes through the door (never to be propped open).

The product as described herein is designed to be used with or without a hard wired alarm system and allows the occupant to use the door as normal without attachments to the door. If the home owner has a fire and security system, then the door opener system can be installed using the magnetic door holder system to maintain the door closer system in the cocked or stowed position. When the alarm is activated the 12-volt supply to the magnet is broken and the door closer is released to close the door.

If the home owner or renter does not have a hard wired system, then they can choose the stand-alone smoke alarm activated system. When the smoke alarm activates it signals a momentary switch, which completes a 9 volt circuit to a DC-DC Boost Module, which then sends a 12-volt signal to the door strike. The mechanism releases the door closer to close the door.

The third option a homeowner has is to use wireless interconnected smoke alarms which send radio frequency (RF) signals from one smoke alarm to the other installed smoke alarms. When any one of the smoke alarms activate, then all of the smoke alarms activate and all of the interior doors close simultaneously throughout the home.

The device is capable of working in several configurations to meet the needs of the property owners. These systems could be installed in rental properties through a hard wired tamperproof installation to reduce property damage during a fire or smoke event such as a cooking fire. The devices can be used to protect individuals confined to a bed, such as small children, injured or handicapped individuals or the elderly who require several minutes to get out of bed or are confined to a bed. In most cases the care providers for these individuals do not want the doors closed between them and the person for which they are caring. With the system described herein the door can remain open or easily be closed when privacy is required as the device does not constantly engage the door. During a fire or smoke event, the doors can automatically close to protect the individual until they can be cared for or rescued. However, with the automated door closers, the doors can still be operated as normal for rescue or escape if required. The closer does not prevent the door from being used, but will continue to close the door until reset.

Many times during a fire event occupants, even those who sleep with the door closed, will exit the home and leave all of the bed room doors open allowing to fire to spread more quickly and increasing the smoke and heat damage. The system described herein may under an embodiment automatically close all interior doors to which a system 10 is installed when the smoke alarm activates, reducing smoke, and heat damage.

As indicated above, a homeowner may use wireless interconnected smoke alarms which send radio frequency (RF) signals from one smoke alarm to the other installed smoke alarms. When any one of the smoke alarms activates, then all of the smoke alarms activate and all of the interior doors (or at least the bedroom doors having an associated closure system 10) will simultaneously close throughout the home.

In one aspect, the interconnected smoke alarms may communicate with each other using ZigBee or Z-Wave wireless networks. ZigBee is a specification for a suite of high-level communication protocols used to create personal area networks built from small, low-power digital radios. ZigBee is based on an IEEE 802.15.4 standard. Though its low power consumption limits transmission distances to 10-100 meters line-of-sight, depending on power output and environmental characteristics, ZigBee devices can transmit data over long distances by passing data through a mesh network of intermediate devices to reach more distant ones. ZigBee is typically used in low data rate applications that require long battery life and secure networking. (ZigBee networks are secured by 128 bit symmetric encryption keys). ZigBee has a defined rate of 250 kbit/s, best suited for intermittent data transmissions from a sensor or input device.

Z-Wave is a wireless communications protocol designed for home automation, specifically for remote control applications in residential and light commercial environments. The technology uses a low-power RF radio embedded or retrofitted into electronic devices and systems, such as lighting, access controls, entertainment systems and household appliances.

Z-Wave communicates using a low-power wireless technology designed specifically for remote control applications. The Z-Wave wireless protocol is optimized for reliable, low-latency communication of small data packets with data rates up to 100 kbit/s, unlike Wi-Fi and other IEEE 802.11-based wireless LAN systems that are designed primarily for high-bandwidth data flow. Z-Wave operates in the sub-gigahertz frequency range, around 900 MHz. This band competes with some cordless telephones and other consumer electronics devices, but avoids interference with Wi-Fi, Bluetooth and other systems that operate on the crowded 2.4 GHz band. Z-Wave is designed to be easily embedded in consumer electronics products, including battery operated devices such as remote controls, smoke alarms and security sensors.

The interconnected network of detection devices and door closure systems may also be communicatively coupled to a LAN. Circuitry within the electronic housing of the door closure system may report system status parameters to the LAN. The LAN may further be coupled to a WAN or more generally to the INTERNET, thereby enabling communication with a remote server hosting at least one application and associated memory for maintaining the status of a network of door closure systems. When monitored parameters of the system change state, the remote server receives notice of the change and may report status information to a mobile computing platform 38 such as a tablet, a laptop or a so-called smartphone. In such manner, a user is able to monitor the status of the door closure system remotely and in real time.

The door control system 10 presented herein provides a residential automated door closer suitable for both new construction and, as a retro-fit to any existing home door. The door closer system allows occupants of a home to use their interior doors as normal without interference, opening, and closing them as they need to, but during a fire or smoke event the automatic door closers will activate with the smoke detector and close all associated interior doors. This non-interference with normal use and automatic closing will buy the time occupant(s) need to move from the bed to the door and check to see if there is smoke or fire outside of the door. If required, the occupants may exit through exterior windows, preferably with the assistance of an escape ladder or a safety net. Also, by closing all interior doors, the growth of fire and smoke will be reduced. Additionally, the potential for less structural damage and personal property damage will take place as well.

It should be understood that the mounting of the system may be reversed as an equivalent device. As such, the device may be mounted to the backside of a door with the arm configured to engage the adjacent wall. Therefore, the terms wall, support structure and the like may be interchanged equally with the term door, including references thereto in the claims.

It should also be understood that other types of rotational force-exerting means, such as an electric motor, may be used as a door closer. It should also be understood that the term spring-biased arm is intended to include arms or devices wherein the spring biasing force is attributed a spring force provided by hydraulic or pneumatic components or other conventionally know means which may force the arm from one position to another.

Also, it should be understood that the system may also utilize a sound detector which recognizes the noise, beep or “chirp” of an activated smoke detector in the same residence. In such an embodiment, the sound detector activates the system 10 upon recognition of a designated frequency. In this embodiment, each smoke detector may have a speaker for broadcasting a sound at a designated frequency, and each smoke detector may additionally have a sound detector configured to recognize the designated frequency and then activate to move associated doors to their respective closed positions.

As can be seen, an improved door closure system is provided herein. The system operates to close the door to a room in a house or an office in response to a signal from a smoke detector, or from another fire detection device. The present system can save lives and reduce property damage to both sprinkled and un-sprinkled structures.

A method of providing a fire-safe environment is also provided herein. The method includes locating a business or a residence having a plurality of smoke detectors therein. Each smoke detector is configured to generate a sound, or chirp, in response to detecting a condition indicative of fire. The method includes incorporating at least one door closure system of the present invention into the business or residence. In this method, each door closure system preferably includes a sound detector that listens for the sound or chirp of the smoke detectors when a fire is indicated. The door closure systems are configured to activate upon detecting a frequency of the sound or chirp made by a smoke detector, as an acoustic signal.

While it will be apparent that the inventions herein described are well calculated to achieve the benefits and advantages set forth above, it will be appreciated that the inventions are susceptible to modification, variation and change without departing from the spirit thereof.

What is claimed is:

1. A door closure system adapted to be coupled to an ancillary electronic device and engage a hinged door, comprising:
a door closer adapted to be mounted to a support structure;
a rotating arm coupled to the door closer, the arm having a proximal end rotatably coupled to the door closer, and a distal end adapted to engage a door when the door closure is activated, wherein the rotating arm is adapted to mechanically move the door from an open position to a closed position upon actuation of the door closer;
an electronic controller adapted to receive an electronic input signal from the ancillary electronic device, and generate an electronic output signal in response thereto, the electronic controller including a battery; and
an electronic strike adapted to engage the rotating arm and to hold the arm in an arm-stowed position, and then release the arm upon receiving an electronic output signal from the electronic controller to allow a force from the door closer to move the arm from its arm-stowed position to a position of engagement with the door, and to close the door.

2. The door closure system of claim 1, wherein the distal end of the rotating arm is separated and unconnected from the door when the rotating arm is in its arm-stowed position.

3. The door closure system of claim 1, wherein the distal end of the rotating arm includes a roller adapted to engage the door upon activation of the door closer.

4. The door closure system of claim 1, wherein the door closer is a mechanically-biased, spring-loaded closer.

5. The door closure system of claim 4, wherein the ancillary electronic device comprises a smoke detector, a heat sensing device, a carbon monoxide detector, or combinations thereof, which produces the electronic input signal to the electronic controller.

6. The door closure system of claim 5, further comprising:
a relay switch configured to receive the electronic input signal from the ancillary electronic device, wherein the relay switch closes a circuit in the electronic controller; and
a voltage converter configured to boost voltage output from the battery and produce the electronic output signal.

7. The door closure system of claim 6, further comprising:
a momentary push button switch coupled to the electronic controller, configured to activate the electronic controller to produce the electronic output signal.

8. The door closure system of claim 1, wherein:
the ancillary electronic device is a smoke detector; and
the smoke detector is in electrical communication or in acoustical communication with a plurality of additional smoke detectors, each of which is configured to send an electrical input signal to an associated door closure system for closing an associated door in response to receiving an electrical or an acoustical signal from the smoke detector.

9. A networked fire protection system, comprising:
a plurality of fire detection devices, wherein each fire detection device of said plurality of fire detection devices is wirelessly coupled to every other fire detection device of said plurality of fire detection devices, and
a plurality of door closing components, each of said fire detection device of said plurality of fire detection devices being in electrical communication or acoustical communication with a corresponding door closing component, each door closing component comprising:
a mechanically-biased door closer adapted to be mounted to a wall adjacent a hinged door,
an rotating arm having a proximal end coupled to the door closer, and a distal end adapted to engage a door and to force the door from an door open position to a door closed position upon actuation of the door closer and resulting movement of the arm,
an electronic controller adapted to receive an input signal from an ancillary electronic device and then generate an electronic output signal in response thereto, the electronic controller including a battery, and
an electronic strike adapted to releasably engage the rotating arm to hold the arm in an arm-stowed position and release the arm upon receiving an electronic output signal from the electronic controller for movement of the arm from its arm-towed position to an engaged position biasing the door towards a door closed position.

10. The door closure system of claim 9, wherein each rotating arm is separate from and unconnected to its corresponding door when the rotating arm is in its stowed position.

11. The door closure system of claim 9, wherein the distal end of the rotating arm of each door closing component includes a roller adapted to contact the hinged door and apply a force when the rotating arm moves to its engaged position.

12. The door closure system of claim 9, wherein the door closer of each door closing component is a spring-loaded closer.

13. The door closure system of claim 9, wherein each fire detection device of said plurality of fire detection devices comprises a smoke detector, a heat sensing device, a carbon monoxide sensor, or a combination thereof, which produces an electrical signal or an acoustical signal to the electronic controller as the input signal.

14. The door closure system of claim 9, wherein each door closing component of said plurality of door closing components further comprises:
a relay switch configured to receive the electronic input signal from its associated ancillary electronic device, whereupon the relay switch closes a circuit in the electronic controller; and
a voltage converter configured to boost voltage output from its corresponding battery and produce the electronic output signal.

15. The door closure system of claim 14, wherein each door closing component of said plurality of door closing components further comprises:
a momentary push button switch coupled to the electronic controller, configured to activate the electronic controller to produce the electronic output signal.

16. A first door closure system for use with an ancillary electronic fire detection device, a hinged door, and an adjacent door support structure, the door closure system comprising:
a mechanically-actuated door closer having a spring-biased arm movable between an arm-stowed position having a potential force and an extended position releasing the potential force so as to move the arm and thereby force the arm against the door, and thereby move the door to a door closed position;
an electronic release mechanism, the electronic release mechanism being movable between a locked position holding the spring-biased arm in its arm-stowed position and a release position disengaged from the arm to allow the release of the potential force to move the arm to its extended position, and thereby move the door to its door closed position; and
an electronic controller electronically coupled to the electronic release mechanism so as to control actuation of the electronic release mechanism, the electronic controller being configured to receive an input signal from the ancillary electronic fire detection device and to deliver an electronic signal output to the electronic release mechanism.

17. The first door closure system of claim 16, wherein the spring-biased arm comprises a proximal end rotatably connected to the door closer, and a distal end that is separated from the door when the spring-biased arm is in its arm-stowed position.

18. The first door closure system of claim 17, wherein the distal end of the spring-biased arm includes a roller adapted to engage the door when the arm moves to its extended position.

19. The first door closure system of claim 18, wherein the ancillary electronic fire detection device comprises a smoke detector, a heat sensing device, a carbon monoxide sensor, or combinations thereof, and is configured to produce the input signal to the electronic controller upon detection of a condition indicative of a fire, the presence of carbon monoxide, or both.

20. The first door closure system of claim 19, wherein:
the ancillary electronic fire detection device is a first smoke detector;
the first smoke detector is in communication with at least a second smoke detector;
the second smoke detector is configured to send an input signal to an electronic controller associated with a second door closure system in response to activation by the first smoke detector in order to activate the second door closure system; and
the input signal is an electrical signal or an acoustical signal.

21. The first door closure system of claim 20, wherein:
the input signal is an acoustical signal;
the first smoke detector is configured to generate a sound in response to detecting a condition indicative of fire; and
the second smoke detector includes a sound detector which recognizes the sound produced by the first smoke detector, whereupon the second smoke detector sends the input signal to activate the second door closure system and to close an associated door.

22. The first door closure system of claim 20, wherein:
the input signal is an electrical signal;
the first smoke detector is in wired or wireless communication with the second smoke detector; and
the second smoke detector is configured to receive electrical signals from the first smoke detector when the first smoke detector is activated, whereupon the second smoke detector sends the input signal to activate the second door closure system and to close an associated door.

23. A residence having a plurality of hazardous condition detectors, hinged doors, and door closure systems, wherein:
each door closure system is installed in the residence adjacent an associated door;
each door closure system comprises a mechanically-actuated door closer having an arm movable between a stowed position and an extended position so as to move the arm, and thereby force the arm against a surface of the residence;
each door closure system further comprises an electronic controller configured to receive an activation signal from one of the smoke detectors, and in response deliver an electronic signal to cause the arm to move to its extended position and to thereby move its associated door to a door closed position; and
the hazardous condition detectors are in communication with one another so that if one of the plurality of hazardous condition detectors is actuated, each of the door closure systems is activated to move the associated doors to their door closed positions.

24. The residence of claim 23, wherein:
each of the hazardous condition detectors comprises (i) a smoke detector, (ii) a heat sensor, (iii) a carbon monoxide sensing device, or (iv) combinations thereof; and
the hazardous condition detectors are in communication with one another by means of (i) transceivers operating through a wireless communications protocol, (ii) a wired network that receives electrical signals, (iii) sound detectors configured to detect sounds generated at one or more designated frequencies, or (iv) combinations thereof.

25. The residence of claim 24, further comprising:
a transceiver configured to send signals to a remote mobile computing device when one of the hazardous condition detectors is activated, and to receive signals from a remote mobile computing device to cause each of the door closure systems to activate.

26. The residence of claim 24, wherein:
each door closure system is secured to a wall or door frame adjacent to its associated door; and
the surface is a surface of the associated door.

27. The residence of claim 24, wherein:
each door closure system is secured to its associated door; and
the surface is a wall adjacent to the associated door.
